(19) United States
(12) Patent Application Publication
(10) Pub. No.: US 2002/0120489 A1
(43) Pub. Date: Aug. 29, 2002

(54) Method and apparatus for managing information

(76) Inventors: Kazuyuki Matsuda, Ome-shi (JP); Toshio Yoshida, Kunitachi-shi (JP); Tsuyoshi Matsuzaki, Yokohama-shi (JP); Ichirou Kikukawa, Ebina-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/084,467

(22) Filed: Feb. 28, 2002

(30) Foreign Application Priority Data
Feb. 28, 2001 (JP) 2001-055844

(51) Int. Cl. G06F 17/60

(52) U.S. Cl. 705/9

(57) ABSTRACT

There is provided an information management method of managing information generated in a group including a plurality of persons. In case of receiving a first request, first information indicating a hierarchical order of a plurality of jobs is displayed on a screen. In case of receiving a second request, second information indicating a time sequence in executing the plurality of jobs is displayed on a screen. In case of receiving a third request, third information indicating a relationship between each job and a final product finally produced in executing that job is displayed on a screen. In case of receiving a fourth request, fourth information indicating a relationship between each job and an intermediate product generated during that job is displayed on a screen.

### CROSS-REFERENCE TO RELATED APPLICATIONS

This application is based upon and claims the benefit of priority from the prior Japanese Patent Application No. 2001-055844, filed Feb. 28, 2001, the entire contents of which are incorporated herein by reference.

### BACKGROUND OF THE INVENTION

1. Field of the Invention

The present invention relates to a method and an apparatus for managing information generated in a group such as an enterprise or the like.

2. Description of the Related Art

In recent years, in a group such as an enterprise or the like, various kinds of software are used in correspondence with purposes so as to support collaborations. Typical software programs include: (1) software for intra-group communications (and know-how accumulation) using an electronic bulletin board or the like (groupware); (2) software that handles personal job lists including personal agendas (groupware); (3) software that handles the routine flow of jobs (workflow management system); and (4) software that manages the job organization (overall classification and formation) (project management system).

Software (1) allows respective persons to write information from their terminals on an electronic bulletin board or the like shared in the group, thus making intra-group communications and accumulating know-how.

Software (2) manages jobs, personal agendas, and the like of persons assigned to these jobs in the group on a single list (to be referred to as a ToDo list hereinafter).

Software (3) manages the workflow using charts and the like, which indicate the routine flow of jobs.

Software (4) manages the job organization (overall classification and formation) for a given project.

With software (1), when a certain person writes information that requires “know-how” for a given job in groupware using an electronic bulletin board, as shown in FIG. 1, another person can write a “reply” to this information, or when still another person writes information that requires “reference information” for a given job, a plurality of persons can write contents of “replies” to that information, thus making intra-group communications and accumulating know-how.

However, a system that uses the bulletin board handles comments and exchanges among persons assigned to these jobs, which are not handled as formal information in making a job. For example, it is difficult for that system to manage a plurality of “activity instructions” generated in business operation in association with each other, or to manage “activity instructions”, “information of products generated as a result of activities”, and “activity items that must be personally remembered” in association with each other. To manage such information, a dedicated mechanism must be developed around the system or a mechanism that liaises with another system which handles final products and the like must be developed.

With software (2), the groupware using the ToDo list can manage a plurality of “activity instructions” and “activity items that must be personally remembered” (each of such elements will be referred to as “action information” hereinafter) generated in business operation, as shown in FIG. 2.

However, it is difficult for the system using the ToDo list to manage a plurality of “activity instructions” in association with each other, and to manage “activity instructions” and “know-how” for a job or “reference information” and “information of products generated as a result of activities” in association with each other. In this case as well, a dedicated mechanism must be developed around the system or a mechanism that liaises with another system which handles final products and the like must be developed.

With software (3), the workflow management system can manage a plurality of “activity instructions” in association with each other, and can manage “activity instructions” and “information of a product generated as a result of activities” in association with each other, as shown in FIG. 3.

However, since the workflow management system manages jobs in consideration of the flow of jobs for respective parts, it is difficult for that system to manage fluid information (that changes constantly) and emergent information generated in daily business. For example, it is difficult to manage “activity instructions” and “activity instructions during temporary development work” or “emergent activity instruction” in association with each other, or to manage “activity items that must be personally remembered”. In such case as well, a dedicated mechanism must be developed around the system or a mechanism that liaises with another system which handles final products and the like must be developed.

With software (4), the project management system can manage a plurality of “activity instructions” in association with each other, and can manage “activity instructions” and “know-how and reference information” in association with each other, as shown in FIG. 4.

However, it is difficult for the project management system to manage, e.g., “information of products generated as a result of activities”, “a plurality of pieces of know-how and reference information (including replies to these pieces of information)”, and “activity items that must be personally remembered”. In such case as well, a dedicated mechanism must be developed around the system or a mechanism that liaises with another system which handles final products and the like must be developed.

As described above, the roles of the respective conventional systems are based on specific viewpoints, and a plurality of products must be used for respective purposes to allow horizontal (comprehensive) information handling in a group. Hence, the user must use different interfaces (inconvenience viewed from the user) for respective software products. Since data distributed in a plurality of software products must be referred to, the user of the software systems must make a search which does not necessarily go well with human perception.

In integrating such various conventional systems, if three systems A, B, and C are to be linked, three development jobs (software development jobs for system integration) between A and B, B and C, and C and D are required. Furthermore, when four systems A, B, C, and D are to be linked, six development jobs are required. In this way, much labor is required for system integration with increasing the number of systems, and much development cost is required to handle comprehensive information.

Under the circumstances, demands have arisen for an information management technique capable of efficiently and integrally managing a broad range of information generated in a group such as an enterprise or the like, thereby horizontally handling information.

### BRIEF SUMMARY OF THE INVENTION

According to one aspect of the present invention, there is provided an information management method of managing information generated in a group including a plurality of persons, the method comprising: managing first information indicating a hierarchical order of a plurality of jobs, second information indicating a time sequence in executing the plurality of jobs, third information indicating a relationship between each job and a final product finally produced in executing that job, and fourth information indicating a relationship between each job and an intermediate product generated during that job; and selectively displaying the first to fourth information to be managed on a screen.

According to another aspect of the present invention, there is provided an information management apparatus for managing information generated in a group including a plurality of persons, the apparatus comprising: a management unit configured to manage first information indicating a hierarchical order of a plurality of jobs, second information indicating a time sequence in executing the plurality of jobs, third information indicating a relationship between each job and a final product finally produced in executing that job, and fourth information indicating a relationship between each job and an intermediate product generated during that job; and a display control unit configured to selectively display the first to fourth information managed by the management unit on a screen.

According to still another aspect of the present invention, there is provided a recording medium storing computer-executable program code for managing information generated in a group including a plurality of persons, the program code comprising: displaying first information indicating a hierarchical order of a plurality of jobs on a screen in case of receiving a first request; displaying second information indicating a time sequence in executing the plurality of jobs on a screen in case of receiving a second request; displaying third information indicating a relationship between each job and a final product finally produced in executing that job on a screen in case of receiving a third request; and displaying fourth information indicating a relationship between each job and an intermediate product generated during that job on a screen in case of receiving a fourth request.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for explaining conventional software such as a bulletin board system for intra-group communications;

FIG. 2 is a view for explaining conventional software that handles a ToDo list;

FIG. 3 is a view for explaining conventional software that handles the routine flow (workflow) of jobs;

FIG. 4 is a view for explaining conventional software (project management system) that manages the job organization;

FIG. 5 is a conceptive view showing a system of information to be managed by an embodiment of the present invention;

FIG. 6 is a conceptive view showing the information relationship from a viewpoint different from FIG. 5;

FIG. 7 is a block diagram showing an example of the system arrangement of hardware for implementing information management according to the embodiment;

FIG. 8 shows an example of a list display window in the embodiment;

FIG. 9 is a view for explaining the hierarchical order structure of jobs in the embodiment;

FIG. 10 shows an example of a display window that shows the hierarchical order of jobs in the embodiment;

FIG. 11 shows an example of a display window used to register job products in the embodiment;

FIG. 12 shows an example of a display window that shows the time sequence in practicing jobs in the embodiment;

FIG. 13 is a view showing Gantt chart display that expresses only the hierarchical order of jobs in the embodiment;

FIG. 14 is a view showing Gantt chart display that expresses only the sequence of jobs in the embodiment;

FIG. 15 shows an example of a display window that implements functions of a meeting support system in the embodiment; and

FIG. 16 shows an example of a display window that implements functions of a bulletin board system in the embodiment.

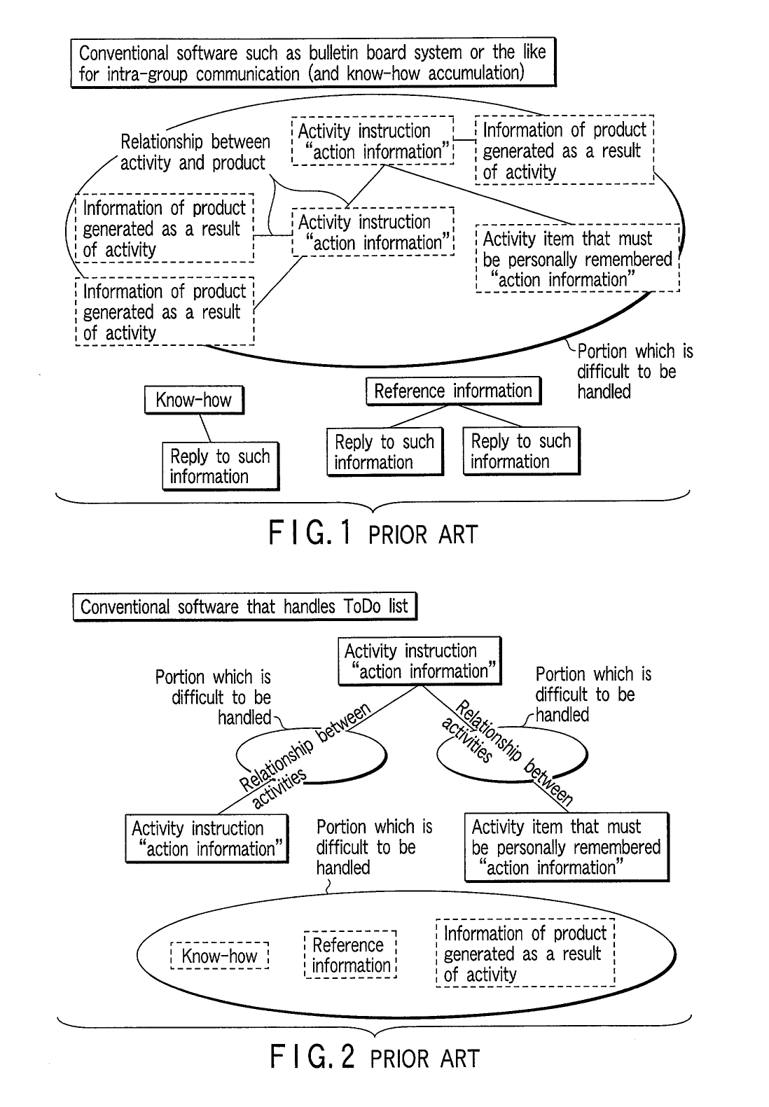

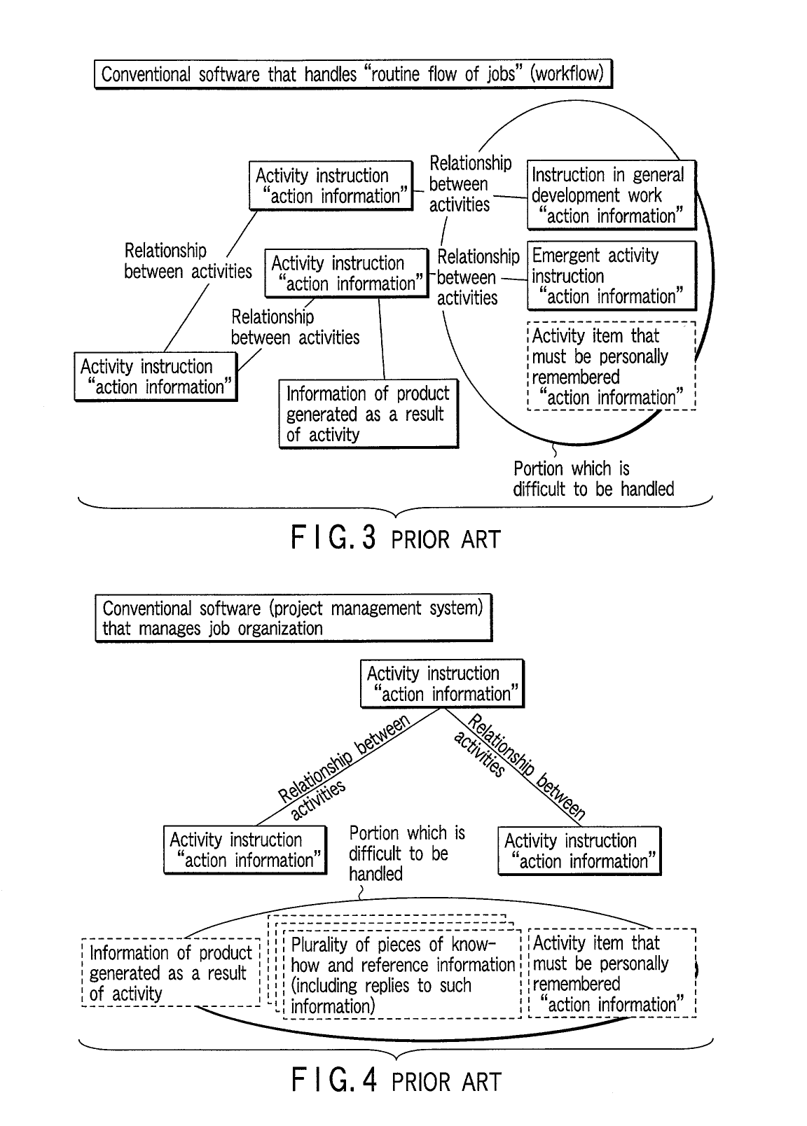

### DETAILED DESCRIPTION OF THE INVENTION

An embodiment of the present invention will be described hereinafter with reference to the accompanying drawings.

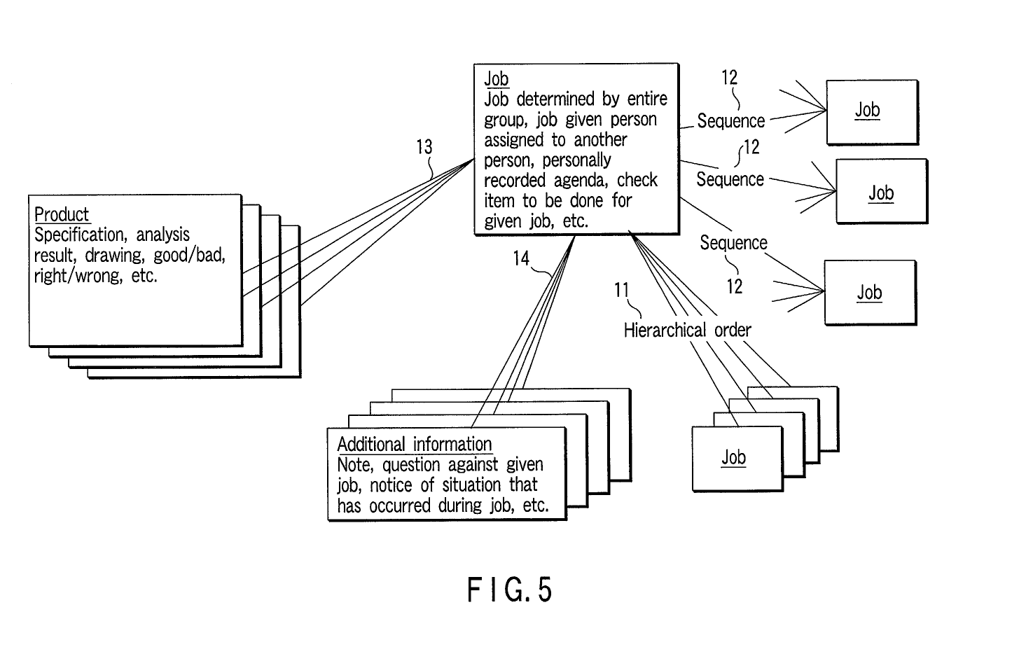

FIG. 5 shows a system of information to be managed by an embodiment of the present invention.

In this embodiment, the following three pieces of information are handled on software.

(A) Information of “job”

Examples of “jobs” include “design LCD” (a job determined by the entire group), “execute strength verification activity by Mr. Matsuzaki (person assigned to this job) until 12/25” (a job a person assigned to another person), “check if prescribed range is exceeded” (personally recorded agenda/check item to be done for given job), . . . .

(B) Information of “product” (final object) generated as a result of jobs

Examples of “products” include “specification”, “analysis result”, “drawing”, “good/bad”, “right/wrong” (determined items), . . . .

(C) Information of “additional information” (intermediate products) exchanged via jobs

Examples of “additional information” include “note for given job that another person assigned to this job contacted”, “question in practicing given job”, “notice of design change that takes place during job (design)”, . . . .

The following relationships of the aforementioned information are managed on software.

(1) Hierarchical order 11 between “job” and “job”

The hierarchical order 11 corresponds to the relationship between a job “design housing of personal computer” and a job “create specification for portion of cover housing of personal computer” as a part of the former job.

(2) Sequence 12 between “job” and “job”

The sequence 12 corresponds to the relationship between a job “create specification” and a job “examine production procedure based on specification” which is done after the former job.

(3) Relationship 13 between “job” and “product” of that job

For example, in case of a job “create specification”, the relationship 13 corresponds to that between the job and “specification” as a product of that job.

(4) Relationship 13 between “job” and “additional information” generated during that job

For example, the relationship 13 corresponds to that between a job “analyze strength” and an advise “tool . . . is preferably used to analyze strength”.

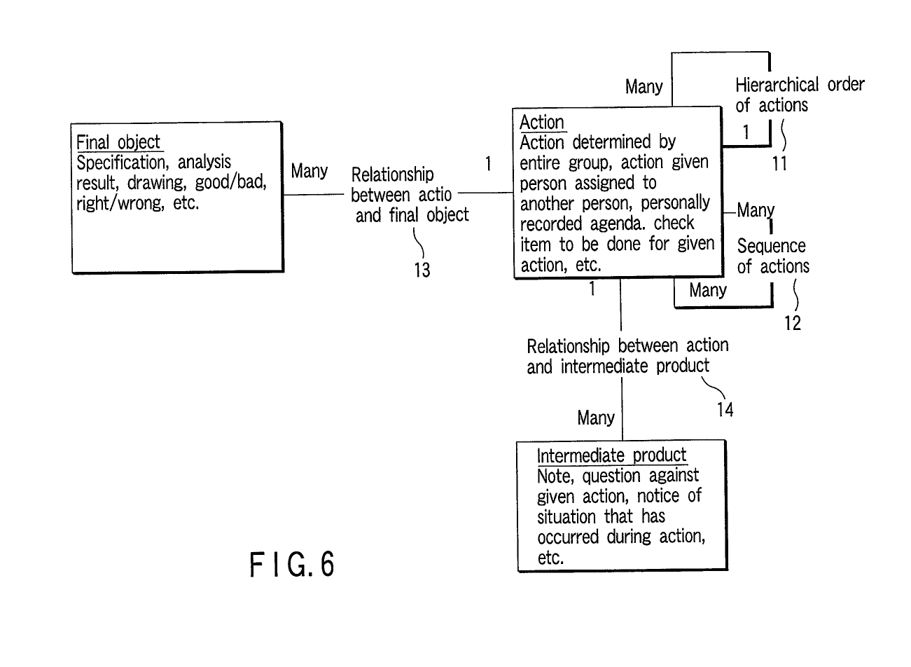

FIG. 6 is a conceptive view showing the information relationship from a viewpoint different from FIG. 5. Note that FIG. 6 uses a term “action” as a concept common to “job determined by entire group”, “job a person assigned to another person”, “personally recorded agenda/check item to be done for given job”, and the like. As can be seen from FIG. 6, the hierarchical order between “action” and “action” is a one-to-many relationship (one or a plurality of lower-level actions are associated with one upper-level action), the sequence between “action” and “action” is a many-to-many relationship (a plurality of actions of identical levels are associated with each other), the relationship between “action” and “final object” is a one-to-many relationship (one or a plurality of final objects are associated with one action), and the relationship between “action” and “intermediate product” is a one-to-many relationship (one or a plurality of intermediate products are associated with one action).

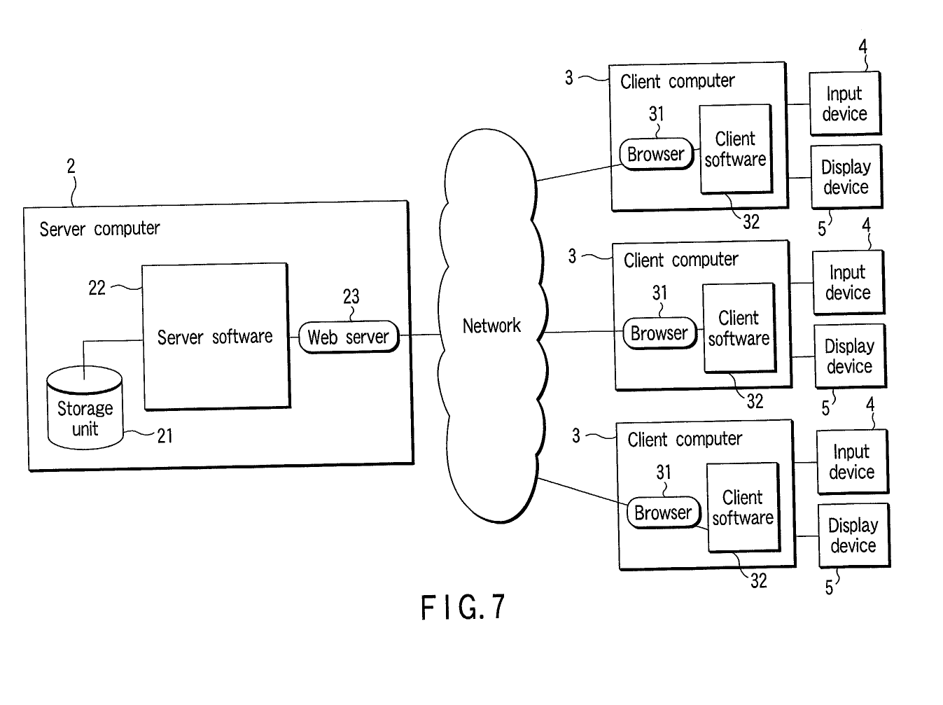

FIG. 7 shows an example of the system arrangement of hardware for implementing information management according to this embodiment.

As shown in FIG. 7, this system comprises one server computer 2 and a plurality of client computers 3, which are connected via, e.g., a network. The server computer 2 comprises a storage unit 21, server software 22, and a web server 23, and each client computer 3 comprises client software 31 and a browser 32. The client computer 3 also comprises an input device 4 such as a keyboard, mouse, and the like, and a display device 5.

The storage unit 21 stores (A) information of “job” (action), (B) information of “product” (final object), and (C) information of “additional information” (intermediate product) described above, and also stores (1) information indicating the hierarchical order between “job” and “job”, (2) information indicating the sequence between “job” and “job”, (3) information indicating the relationship between “job” and “product” of that job, and (4) information indicating the relationship between “job” and “additional information” generated during that job.

The server software 22 appropriately selects and reads out information stored in the storage unit 21 in response to a request sent from the client computer 3, and provides the information to the client computer 3 as a request source via the web server 23. The server software 22 controls to maintain consistency among the four kinds of information (1) to (4) above. When any information has changed, the server software 22 processes to automatically reflect the change contents in other kinds of information.

The web server 23 establishes connection to the network, and exchanges information between the server computer 2 and client computers 3.

On the other hand, the browser 31 in each client computer 3 fetches required information from the server computer 2 via the network in response to a request issued by the client software 32.

The client software 32 executes a process for fetching information in accordance with an instruction from the input device 4, and displays information fetched by the browser 31 on the screen of the display device 5.

An example of software that implements the information management method according to the present invention will be explained below. The software to be described below manages jobs and various kinds of peripheral information generated in an enterprise, and can pick up information as needed.

In this software, “product” is expressed as “attachment file” generated as a result of an activity. The entity of “attachment file” is a file on a computer or a URL (a character string of file information accessible from a Web browser via the Internet).

Also, in this software, “additional information” is expressed as “comment” exchanged in association with a given job. The entity of “comment” is a document of mail or a mail document having no specific address (a document for only the publication purpose). Also, “comment” contains a file appended to a document.

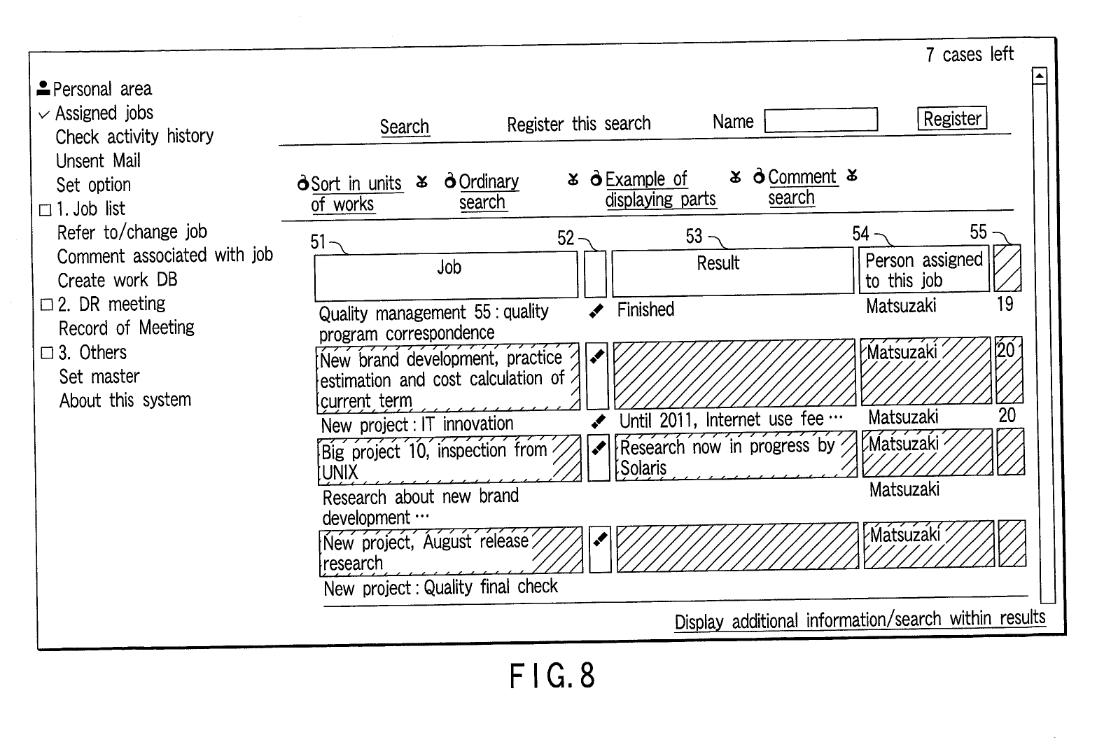

The display windows shown in FIG. 8 and FIGS. 10 to 16 to be described below have items for opening other display windows. When the user selectively clicks an item, the display window can be switched to a desired display window.

FIG. 8 shows an example of a list display window (view) displayed on the display device 5 of the client computer 3.

When the user operates the input device 4 of the client computer 3 to log in the system, the list display window shown in FIG. 8 appears on the display device 5.

The list display window of FIG. 8 displays a i“result” column 52, “attribute” column 53, “person assigned to this job” column 54, “delivery date” column 55, and the like in correspondence with jobs together with a “job” column 51. Especially, in displaying “job”, jobs that the use's boss commanded the user, and jobs left as the user's agenda are equally handled. This list display window implements a function of a ToDo list of a specific person (each person assigned to this job).

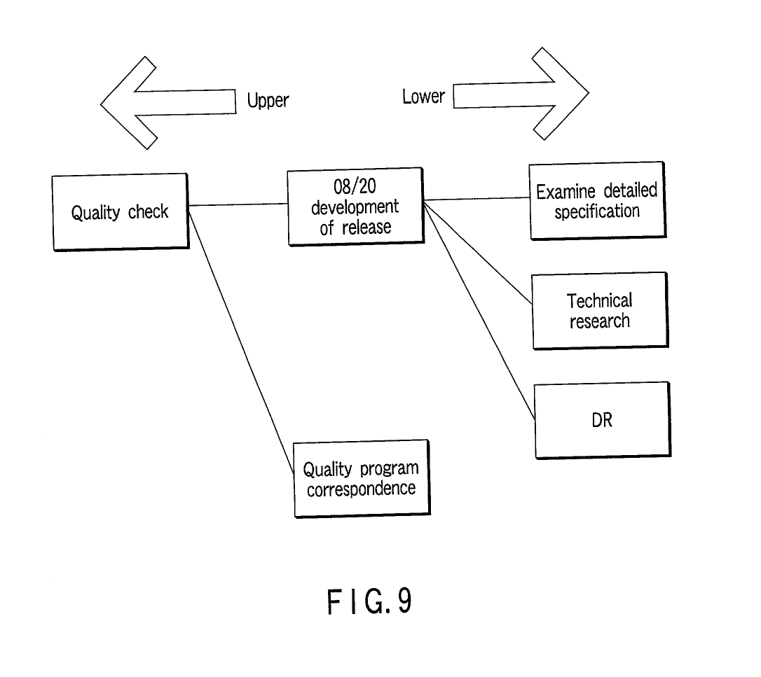

Note that a job located at the uppermost position on the job hierarchical order structure corresponds to a project. For example, in an example shown in FIG. 9, an upper-level job “quality check” is a project. In this case, middle-level jobs “08/20 development of release” and “quality program correspondence” are located below “quality check”, and lower-level jobs “examine detailed specification”, “technical research”, and “DR (design review)” are located below “08/20 development of release”.

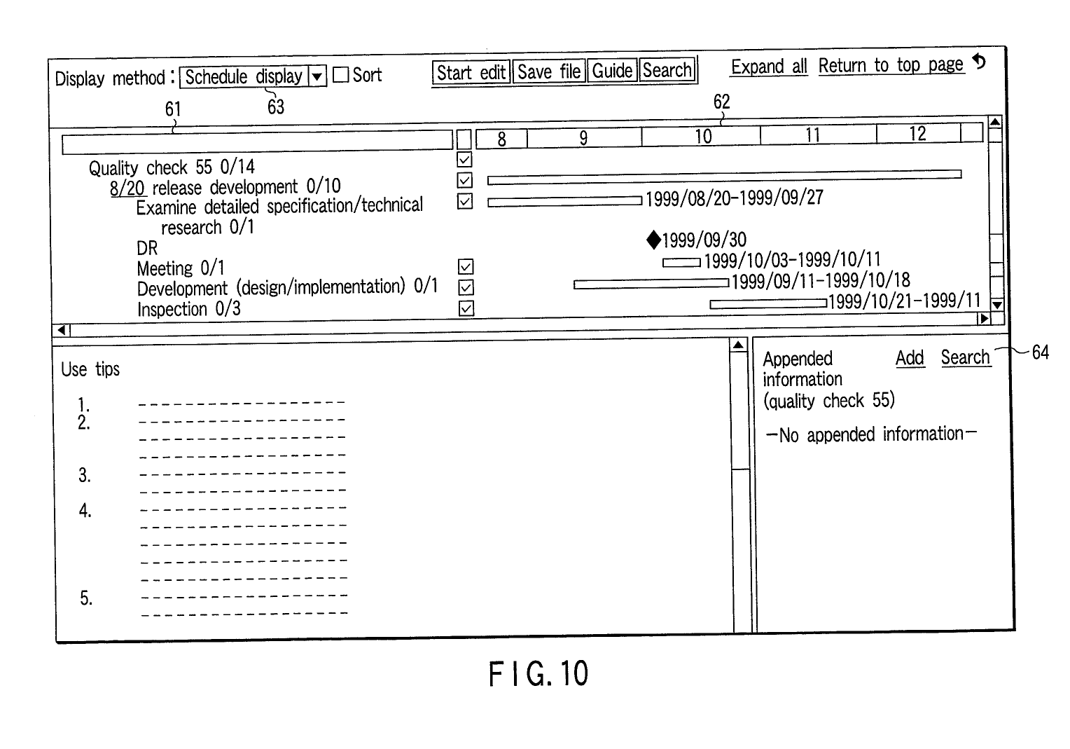

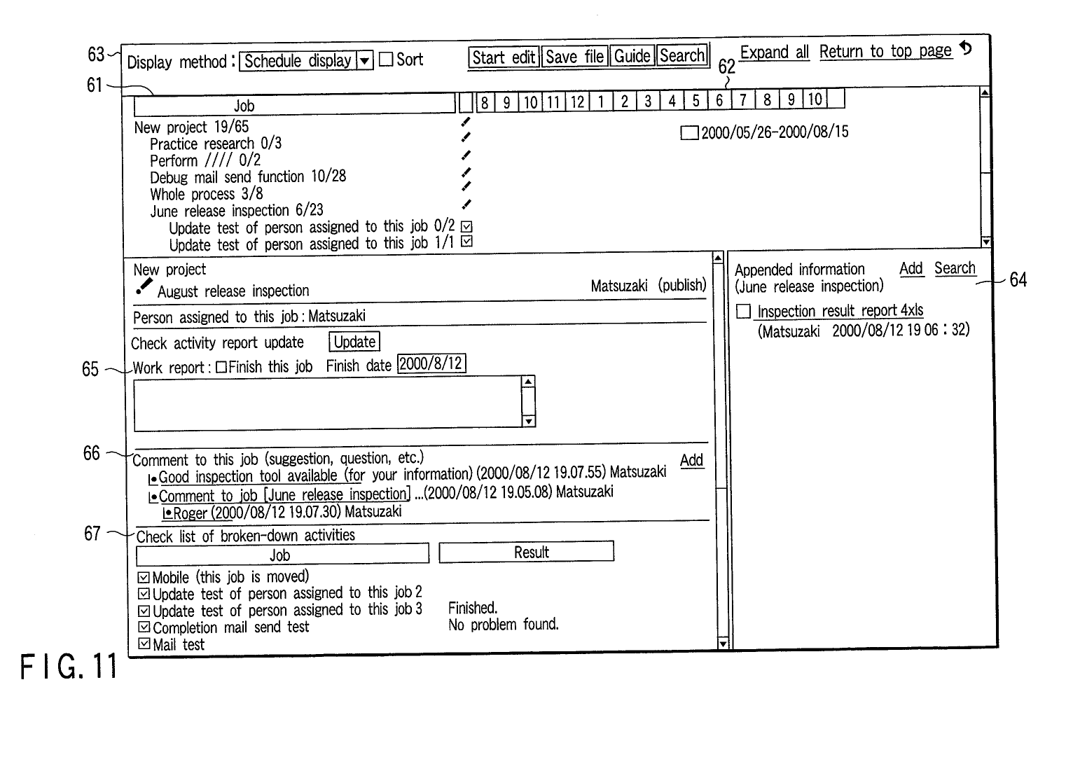

FIG. 10 shows an example of a display window (view) that shows the hierarchical order of jobs associated with a given project.

To display the display window of FIG. 10, for example, the user can click a desired project on the list display window of FIG. 8.

In the example shown in FIG. 10, a project name “quality check 55” is located as an upper-level job, a middle-level job “8/20 release development” is located below that project name, and lower-level jobs “examine detailed specification/technical research”, “DR”, and the like are located below that job. In FIG. 10 as well, jobs that the user's boss commanded the user, and jobs left as the user's agenda are displayed without any distinctions.

A schedule column 62 is assured on the right side of a job column 61, and displays schedules corresponding to jobs.

Note that a display method column 63 in which the user can designate a desired display method is assured on the upper left position of the window, and FIG. 10 shows a state wherein “schedule display” is designated. Also, a column 64 in which the user registers products of jobs as attached information is assured.

FIG. 11 shows an example of a display window (view) used to register products generated as a result of jobs.

In the example of FIG. 11, a project name “new project” is located as an upper-level job, middle-level jobs “practice research”, “perform ////”, “debug mail sending function”, “whole process”, and “June release research” are located below that project name. FIG. 11 shows a case wherein a product of the job “June release research” of these jobs is to be registered. In FIG. 11 as well, jobs that the user's boss commanded oil the user, and jobs left as the user's agenda are displayed without any distinctions.

The user clicks “add” in the attached information column 64 to register a job product in the form of an attachment file. In the example in FIG. 11, a file “activity report” as a product has already been registered.

On the lower left portion of the window, an activity report column 65, column 66 of comments to a job, broken-down activity check list column 67, and the like are displayed. In the column 65, a person assigned to this job writes an activity report of the job. Also, the column 66 shows comments concerning the job (additional information including suggestions, questions, and advises sent to the person assigned to that job via mail messages or the like, replies thereto, and the like). In the column 67, a person assigned to this job writes results of broken-down activities (lower-level jobs) as needed.

Note that the display window of FIG. 11 can be reached from the window of either FIG. 8 or 10.

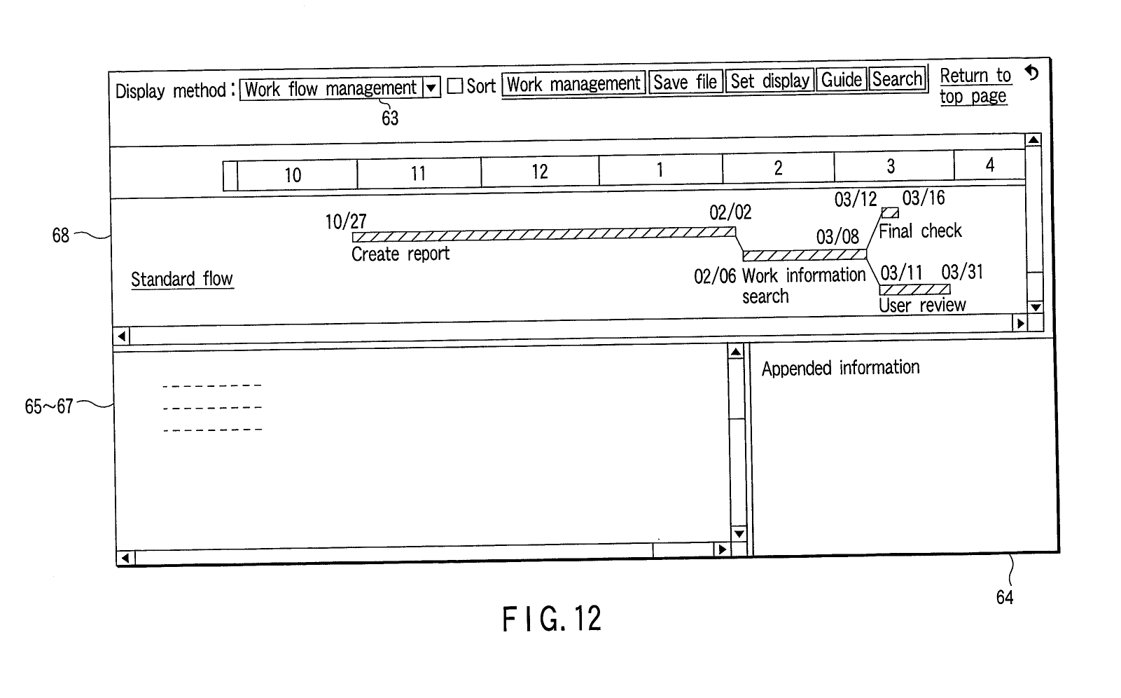

FIG. 12 shows an example of a display window (view) showing the time sequence in practicing jobs.

When the user designates “workflow management” from the display method column 63, a workflow (Gantt chart) column 68 of an objective job is displayed.

In the example of FIG. 12, the workflow column 68 displays a state wherein the workflow is set in the form of 10/27 to 02/02: create report, 02/06 to 03/08: work information search, 03/12 to 03/16: final confirmation, and 03/11 to 03/31: user review. With this workflow, the user can recognize the time sequence of jobs.

Note that the user can register products using the column 64 and columns 65 to 67 on the display window of FIG. 12 as in FIG. 11.

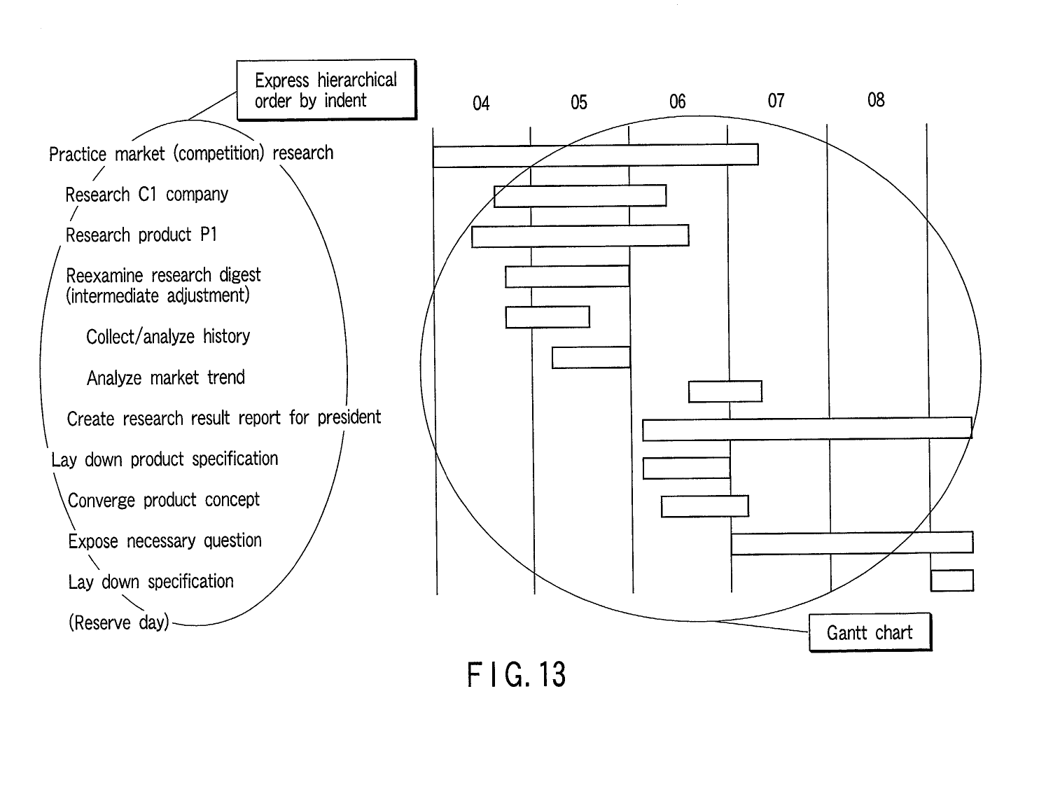

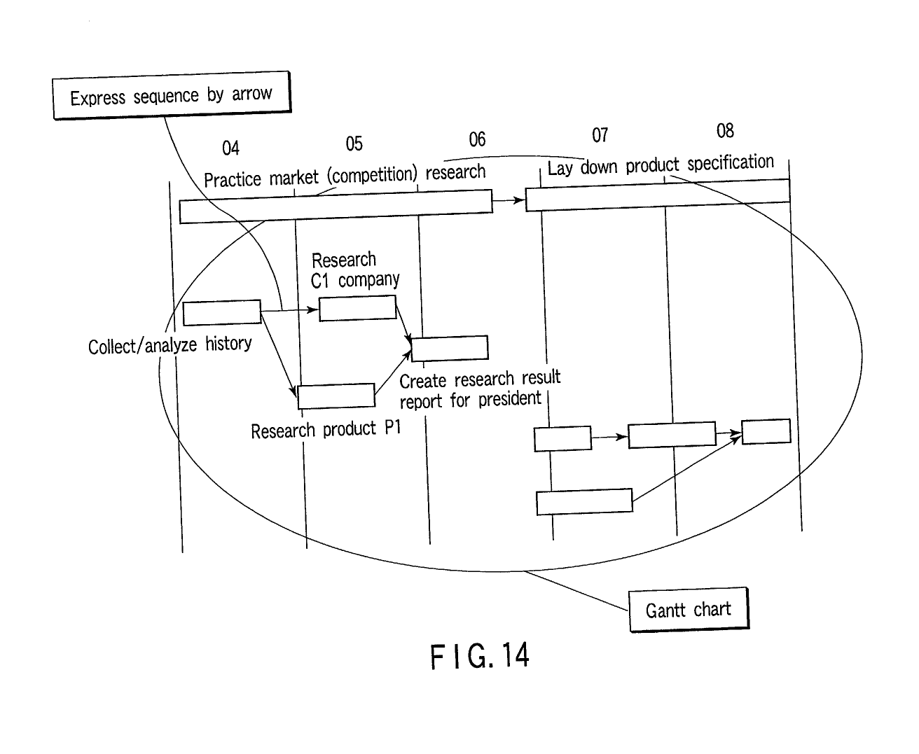

On the Gantt chart column 68, a Gantt chart which expresses only the hierarchical order of jobs and that which expresses only the sequence of jobs may be displayed on independent windows, as shown in FIGS. 13 and 14. On both the examples of FIGS. 13 and 14, job schedules (period, finish date, and the like) of jobs can be recognized. As in these examples, when the Gantt chart which expresses only the hierarchical order of jobs and which expresses only the sequence of jobs can be displayed on independent windows, information can be easily arranged from a single viewpoint, and display with expression that allows easy confirmation can be provided according to the purpose of use.

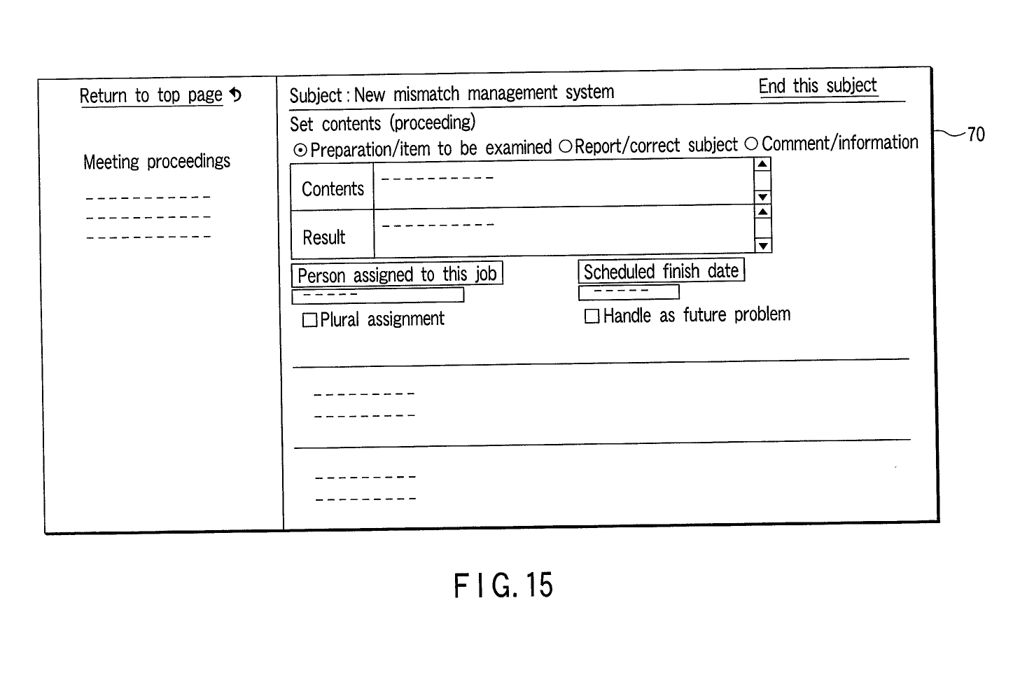

FIG. 15 shows an example of a display window that implements the functions of a meeting support system.

In the example of FIG. 15, a column 70 used to register the proceedings of a subject “new mismatch management system” is displayed. In this column 70, the user selects one of “preparation/item to be examined”, “report/correct subject”, and “comment/reference”, writes “contents” and “result”, and also writes “person assigned to this job” and “scheduled finish date”. Also, check boxes for designating “plural assignment” and “handle as future problem” are provided.

Respective proceedings registered on this window are reflected (added) in information on the windows of, e.g., FIGS. 10 and 12 as jobs (actions).

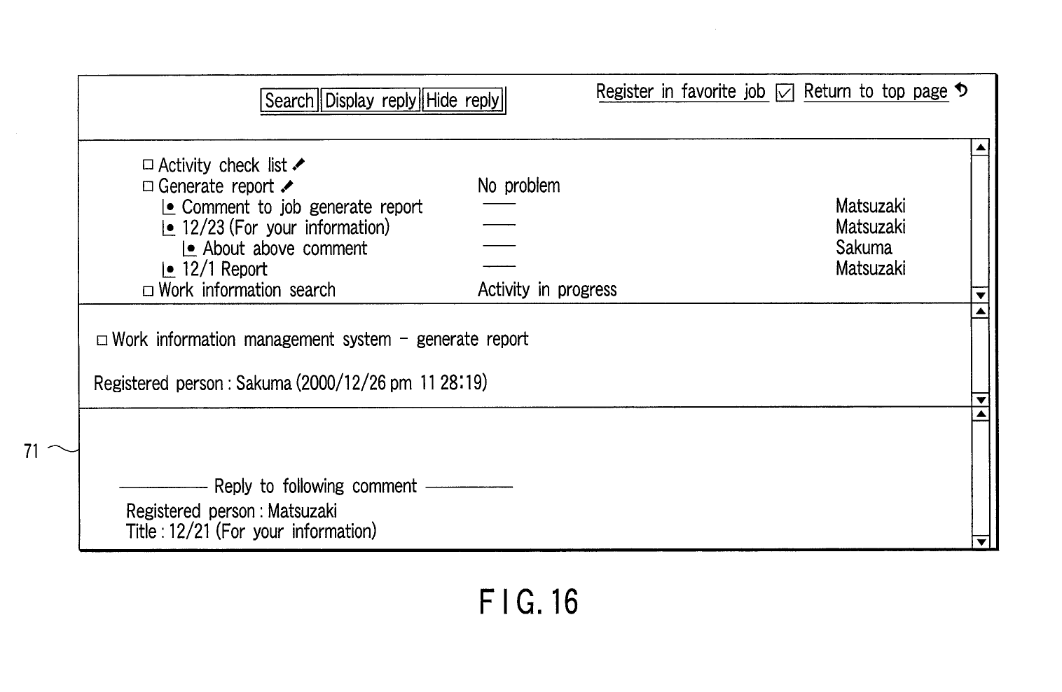

FIG. 16 shows an example of a display window (view) that implements the functions of a bulletin board system.

In the example of FIG. 16, a column 71 used to register a comment (suggestion or the like) addressed to the person assigned to a job “create report” is displayed. In this column 71, the user can write required items such as “registration person”, “title”, and the like.

Comments registered on this window are reflected in the comment column 66 of the corresponding job shown in, e.g., FIG. 11. For this reason, the person assigned to that job can view the comments displayed on the window of FIG. 11.

As described above, according to this embodiment, software that can efficiently integrate the functions of respective kinds of software such as groupware (ToDo list or the like), workflow management, and project management, and can horizontally handle information can be provided.

Since the software according to this embodiment comprises not only the management function of general jobs but also a personal schedule management function and the like, it can be applied to browsing using a PDA terminal or the like. In executing schedule management on a PDA terminal, by adding attribute information such as a scheduled start/finish date or the like, schedules of jobs that a member of an enterprise requires of that person, and those personally registered as an agenda can be handled in a standardized format without any distinctions.

The software according to this embodiment can also be applied to browsing using page browsing software on a portable telephone.

The present invention is not limited to the above embodiment, and various changes and modifications may be made within the scope of the invention.

The various processing procedures associated with the present invention described in the above embodiment may be stored in advance as computer-executable program codes in a computer-readable storage medium (e.g., a magnetic disk, optical disk, or semiconductor memory). Such a program may be read out from the medium by a computer (processor) to be executed, as needed. Such computer-executable program codes may be transmitted and distributed from a given computer to another computer through a communication medium.

As described above, according to the present invention, a broad range of information generated in a group such as an enterprise or the like can be efficiently and integrally managed, and information can be horizontally handled.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information management method of managing information generated in a group including a plurality of persons, said method comprising:
managing first information indicating a hierarchical order of a plurality of jobs, second information indicating a time sequence in executing the plurality of jobs, third information indicating a relationship between each job and a final product finally produced in executing that job, and fourth information indicating a relationship between each job and an intermediate product generated during that job; and
selectively displaying the first to fourth information to be managed on a screen.

2. The method according to claim 1, wherein the plurality of jobs include a job generated in the group, and a job generated by a person.

3. The method according to claim 1, wherein the selectively displaying includes displaying one of the first to fourth information in response to a request from a person in a form which integrates a job associated with that person and a job generated in the group.

4. The method according to claim 1, wherein the first to fourth information are managed by a server computer, and one of the first to fourth information is sent from the server computer to a client computer in response to a request from the client computer.

5. The method according to claim 1, wherein the selectively displaying includes displaying a Gantt chart which expresses the hierarchical order of the plurality of jobs and a Gantt chart which expresses the sequence of the plurality of jobs on independent screens.

6. An information management apparatus for managing information generated in a group including a plurality of persons, said apparatus comprising:
a management unit configured to manage first information indicating a hierarchical order of a plurality of jobs, second information indicating a time sequence in executing the plurality of jobs, third information indicating a relationship between each job and a final product finally produced in executing that job, and fourth information indicating a relationship between each job and an intermediate product generated during that job; and
a display control unit configured to selectively display the first to fourth information managed by the management unit on a screen.

7. The apparatus according to claim 6, wherein the plurality of jobs include a job generated in the group and a job generated by a person.

8. The apparatus according to claim 6, wherein said display control unit displays one of the first to fourth information in response to a request from a person in a form which integrates a job associated with that person and a job generated in the group.

9. The apparatus according to claim 6, wherein the first to fourth information are managed by a server computer, and one of the first to fourth information is sent from the server computer to a client computer in response to a request from the client computer.

10. The apparatus according to claim 6, wherein said display control unit displays a Gantt chart which expresses the hierarchical order of the plurality of jobs and a Gantt chart which expresses the sequence of the plurality of jobs on independent screens.

11. A recording medium storing computer-executable program code for managing information generated in a group including a plurality of persons, said program code comprising:
displaying first information indicating a hierarchical order of a plurality of jobs on a screen in case of receiving a first request;
displaying second information indicating a time sequence in executing the plurality of jobs on a screen in case of receiving a second request;
displaying third information indicating a relationship between each job and a final product finally produced in executing that job on a screen in case of receiving a third request; and
displaying fourth information indicating a relationship between each job and an intermediate product generated during that job on a screen in case of receiving a fourth request.

12. The medium according to claim 11, wherein the plurality of jobs include a job generated in the group and a job generated by a person.

13. The medium according to claim 11, wherein the selectively displaying includes displaying one of the first to fourth information in response to a request from a person in a form which integrates a job associated with that person and a job generated in the group.

14. The medium according to claim 11, wherein the selectively displaying includes displaying a Gantt chart which expresses the hierarchical order of the plurality of jobs and a Gantt chart which expresses the sequence of the plurality of jobs on independent screens.
